(19) United States
(12) Patent Application Publication
(10) Pub. No.: US 2010/0227997 A1
(43) Pub. Date: Sep. 9, 2010

(54) METHOD FOR PREPARING ISOCYANATE ADDUCTS

(75) Inventors: Martin Fiene, Niederkirchen (DE); Ralf Boehling, Lorsch (DE); Eckhard Stroefer, Mannheim (DE); Herbert Vogel, Nauheim (DE); Fatima Mesri, Karlsruhe (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF Aktiengesellschaft, Ludwigshafen (DE)

(21) Appl. No.: 11/916,600

(22) PCT Filed: Jun. 14, 2006
(86) PCT No.: PCT/EP2006/063231

§ 371 Date: Dec. 5, 2007

(30) Foreign Application Priority Data
Jun. 15, 2005 (DE) 10 2005 027 814.0

(51) Int. Cl. C08G 18/08

(52) U.S. Cl. 528/44

(57) ABSTRACT

The present invention provides a process for working up isocyanate adducts, comprising the steps of
a) reacting the isocyanate adducts with pure ammonia,
b) working up the reaction products obtained in step a),
c) recycling the amines formed into the isocyanate production.

The invention provides a process for working up isocyanate adducts such as polyurethanes, residues from isocyanate preparation, especially distillation residues from the preparation of tolylene diisocyanate (TDI) or hexamethylene diisocyanate (HDI).

Isocyanate adducts are obtained as waste in large amounts in industry. Examples are polyurethane foams; here, for example, production wastes or foams from scrapped appliances, motor vehicles or furniture.

A further group of isocyanate adducts is that of production wastes, especially distillation residues, from the preparation of polyisocyanates, especially of tolylene diisocyanate (TDI) or hexamethylene diisocyanate (HDI). Particularly in the preparation of TDI, one of the most widely used polyisocyanates, a large amount of residues is obtained.

TDI is used in large amounts to prepare polyurethanes, especially flexible polyurethane foams. TDI is prepared usually by reacting tolylenediamine (TDA) with phosgene. This process has been known for some time and has been described many times in the literature.

To this end, the TDA is typically reacted with phosgene in a conventional two-stage phosgenation.

At the end of the synthesis, there is typically a distillation step in which the TDI is removed from high-boiling by-products. For process technology reasons, for example in order to ensure the pumpability of the residue, the residue may still comprise up to 70%, preferably up to 50%, more preferably up to 30% TDI. There is thus a considerable economic stimulus for the modern world-scale plants of annual capacity up to several hundred thousand metric tons to recover this residue in material form.

A frequently practiced means of recovering at least some of the TDI present in the distillation residue consists in the further removal of the TDI from the residue, for example by means of an extruder. Suitable apparatuses are, for example, the so-called List driers. These are specific paddle driers from List which frequently find use in isocyanate production. As a result of this, the amount of TDI in the distillation residue can be significantly lowered. However, in this process too, a generally solid residue occurs, by which the yield of the process is lowered. This has to date usually been incinerated.

An alternative means of utilizing the distillation residues is to recover them in material form. For this purpose, various processes are known.

Such a means of utilization is the reaction of the residue with water, known as hydrolysis. Such processes have been described many times. The hydrolysis of the residue is promoted by bases or acids. Amines too promote the hydrolysis. Hydrolysis can be utilized to denature the TDI distillation residue, as described, for example, in U.S. Pat. No. 4,091,009. A further means is the recovery of TDA which can then be reacted again with phosgene to give TDI. Such processes are described, for example, in DE-A-29 42 678, JP-A-5 8201 751 and DE-A-19 62 598.

DE-A-27 03 313 describes a hydrolysis process which can be carried out either batchwise in an autoclave or continuously in a tubular reactor. The hydrolysis of the solid TDI residue is carried out with aqueous ammonia solution, solutions of primary or secondary amines in water or aqueous TDA solution.

U.S. Pat. No. 4,654,443 describes a hydrolysis process in which, in a first process step, the TDI residue is reacted with TDA to give a solid, and, in a second step, this intermediate is hydrolyzed with water. A disadvantage here is that the process comprises two process steps, and that TDA has to be added to the reaction mixture. There is also a high degree of formation of solids.

WO 99/65868 describes a continuous or semicontinuous process for hydrolyzing distillation residues in a backmixed reactor. This process prevents the formation of solids.

JP-A-151 270/97 describes a process for hydrolyzing TDI residues with supercritical or hot high-pressure water. A disadvantage in this process is the very high pressure which necessitates the use of specific apparatuses, and also the corrosion problems which arise from the use of supercritical water and the chlorinated by-products which are frequently still present in the residues. Moreover, it is necessary to work with a high water excess.

WO 04/108656 describes the decomposition of pulverized TDI residues with water below the critical point in the presence of catalysts. In this process too, the formation of solids cannot be ruled out.

KR 383217 describes a process for recovering TDA from distillation residues by reacting with aqueous ammonia solution. In this process, a distillation residue which has a content of free TDI of below 1000 ppm is used. The reaction can be carried out below the critical point, in the region of the critical point or above the critical point of water.

A disadvantage in all of the described processes for working up distillation residues from TDI preparation is that the reaction of the residue with water results in the formation of carbon dioxide and thus an additional pressure buildup in the reactor. When the intention is to recycle the TDA formed in the workup into the production process, it is necessary after the hydrolysis to again remove the water from the reaction mixture in a costly and inconvenient manner, since water traces in the phosgenation, even in the ppm range, leads to corrosion and urea formation. In general, the water is removed by distillation. This step again forms high molecular weight residues which lead to yield losses of TDA formed beforehand. A further disadvantage in the hydrolysis of TDI residues with a water-containing reaction mixture consists in the lower selectivity. The amines formed in the reaction react, as shown in the scheme which follows, in a subsequent reaction with the water to give aminocresols.

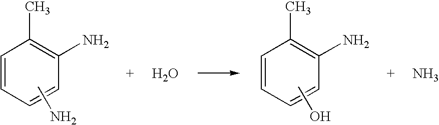

This process too leads to yield losses of TDA.

It was therefore an object of the invention to develop a process for working up isocyanate adducts, such as polyurethanes and distillation residues from the preparation of isocyanates, in particular from TDI preparation, which can be operated in a simple manner and with high yields.

This object is surprisingly achieved by reacting the isocyanate adduct with pure ammonia.

The invention accordingly provides a process for working up isocyanate adducts, comprising the steps of

a) reacting the isocyanate adducts with pure ammonia,
b) working up the reaction products obtained in step a),
c) recycling the amines formed into the isocyanate production.

The isocyanate adducts may be reaction products of the isocyanates with themselves or with compounds having functional groups which can react with isocyanate groups.

Examples of isocyanate adducts are compact or foamed polyurethanes, reaction products of isocyanates with themselves, such as isocyanurates, uretonimines, uretdiones, carbodiimides, and also oligomeric and polymeric reaction products of the isocyanates. In particular, it is possible to use production residues from the preparation of isocyanates, in particular liquid or solid distillation residues from TDI and/or HDI preparation, for the process according to the invention.

When solid production residues or polyurethanes are used, they are first comminuted, preferably to a particle size of <100 mm, preferably <10 mm, more preferably <1 mm. In the case of polyurethane foams, preference is given to compacting, for example by pressing or grinding.

When liquid production residues from the preparation of isocyanates are used, they are usually subjected to the process according to the invention in the liquid state.

The distillation residues from TDI preparation may be fed to the process according to the invention directly from the plant. In one embodiment of the process, the distillation residues can be pumped in the liquid state to the process according to the invention. However, it has to be ensured that the residues do not solidify, since they can then no longer be liquefied. However, it is also possible to allow the residues to solidify and to feed them to the process according to the invention in comminuted form, for example as powder or pellets. In that case, the comminuted residues preferably have the abovementioned particle size.

In a preferred embodiment of the process according to the invention, the free isocyanate is removed from the distillation residues of the isocyanate preparation, especially the preparation of TDI and/or HDI, before the reaction with the ammonia. This can be done, for example, by means of thin-film distillation, but preferably by means of a List drier.

After this treatment, the distillation residue preferably still has a content of free isocyanate of not more than 5000 ppm (g per g). It consists mainly of oligomeric and polymeric isocyanate and carbodiimide adducts. The precise composition depends in each case greatly upon the reaction conditions selected beforehand.

The advantage of this procedure is mainly that the isocyanate already formed in the process is not recovered in material form once more, and the use amount for the process according to the invention is also reduced. Furthermore, in the case of TDI, TDI dimers can be dissociated to TDI in the List drier.

Depending on the size of the streams occurring in the particular plant, it may even be more viable from an economic point of view to subject the distillation residues directly to an ammonolysis without further removal of the monomeric isocyanates.

It is also possible in principle to improve the handling of the isocyanate residues by absorbing them in a suitable organic solvent which does not react with the residue, for example toluene, monochlorobenzene, dichlorobenzene and others. However, this embodiment is not preferred since the solvent has to be removed in a separate step.

The ammonolysis may be carried out either continuously or batchwise. The decision in this regard depends in particular upon the amount of the residues occurring in the particular isocyanate production.

The reaction of the isocyanate adducts with ammonia is carried out in such a way that the ammonia is present in the supercritical state or close to the critical point. Accordingly, the reaction is carried out preferably at a temperature in the range between 100 and 500° C., preferably from 100 to 400° C., more preferably from 100 to 250° C., and a pressure in the range between 100 and 500 bar, preferably from 100 to 400 bar and more preferably 100 and 380 bar.

The ammonia has to be present in an at least equimolar amount with respect to the bond to be cleaved. It is preferably used in an at least 10% molar excess. Since the composition of the residues depends greatly upon the reaction conditions in the preparation process and cannot be precisely determined analytically, the amount of ammonia is reported below in % by weight. The ammonia fraction of the starting components of the process according to the invention is preferably in the range from 10% by weight up to 90% by weight, preferably 30-70% by weight, based on the reaction mixture.

The reaction can be carried out in tubular reactors, in tanks or in stirred tank batteries. The residence time is preferably between 30 seconds and 5 hours, preferably between 1 minute and 1 hour.

The reaction product from the process according to the invention is worked up generally by removing the volatile constituents, especially the excess ammonia, separating the cleavage products and working them up. The cleavage products are firstly the parent amines of the isocyanates and, in the case of ammonolysis of polyurethanes, additionally the parent alcohol components of the polyurethane.

The reaction product of the process according to the invention is usually withdrawn continuously from the reactor and worked up. In the preferred solvent-free process, the reaction product is monophasic in the event of full reaction.

The workup will be described in detail using the example of the TDI residue. The reaction products from other processes, for example HDI, are also worked up in a similar manner.

First, the ammonia used in excess is removed, preferably by flashing and/or stripping, and then the TDA is removed, preferably by means of distillation or crystallization. The ammonia removed can be recompressed and recycled into the ammonolysis or utilized for energy purposes.

After appropriate purification and workup, the TDA removed can either be added to the phosgenation reactor of the TDI process or fed to the reaction mixture which leaves the hydrogenation reactor in TDA preparation by hydrogenation of dinitrotoluene before the workup to give pure TDA. The latter process variant has the advantage that the workup step after the ammonolysis can be simplified or, if appropriate, dispensed with entirely. The by-products of the ammonolysis can then be discharged from the process with the TDA tar in the TDA workup process step.

Residues still remaining after the ammonolysis can be disposed of in the customary manner, for example by incineration. The remaining residues are, for example, unconverted reactants, guanidines or, especially in the case of ammonolysis of polyurethanes, ureas. These by-products can be removed before the amines are recycled into the process for preparing the polyisocyanates. However, it is also possible to feed the TDA in unpurified form to the TDA stream withdrawn from the hydrogenation. In the subsequent purification, the impurities present are also removed.

When polyurethane foams are used in the ammonolysis, the reaction effluent, after the removal of the ammonia, without further workup or after the removal of by-products, can also be used to prepare polyether alcohols by addition of alkylene oxides. It is of course also possible to react the purified TDA with alkylene oxides to give polyether alcohols.

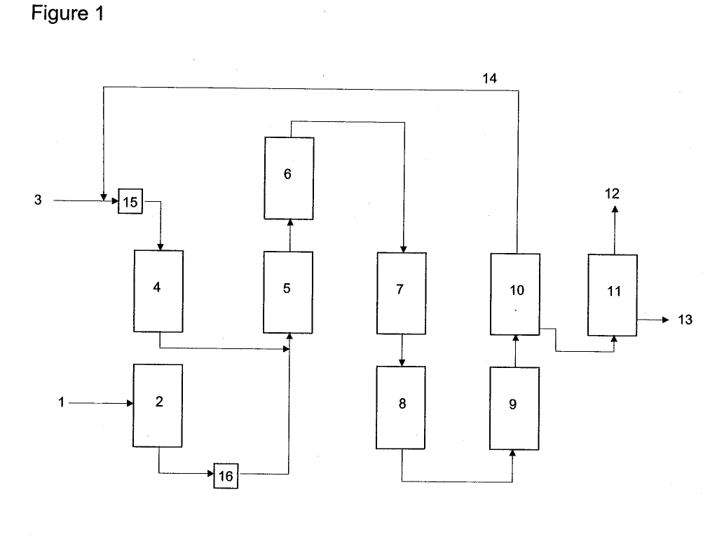

A schematic process flow diagram for the reaction of a liquid isocyanate residue is shown in FIG. 1. In this diagram, the production residue 1 is conducted, either first into a buffer vessel 2 or directly, with a pump 16 to a static mixer 5. From there, it is conveyed with a pump 16 to a static mixer 5 and at the same time brought to the desired pressure level. In the static mixer, it is mixed with ammonia. This ammonia is composed of a feed stream 3 and optionally a recycle stream 14. Both streams are compressed to the desired pressure with the compressor 15 and, if required, stored intermediately in a buffer vessel 4. Both feed streams can in principle be preheated to reaction temperature actually upstream of the static mixer. Supplementarily or else alternatively, there follows a further heat exchanger 6 downstream of the static mixer before the mixture is converted in a reactor 7. Subsequently, the reaction effluent is cooled in a cooler 8 and decompressed in a pressure-retaining apparatus 9. The cooler 8 may in principle also be designed as a thermally integrated apparatus in which, for example, the circulation stream 14 is preheated. In a separator 10, the liquid TDA-containing phase is removed from the excess ammonia. The ammonia phase is recycled as circulation stream 14 and fed back in again upstream of the compressor 15. The amine formed is distilled off from unconverted residue 13 in a downstream column 11. The amine thus purified can be reused in an isocyanate plant. The residue 13 is disposed of.

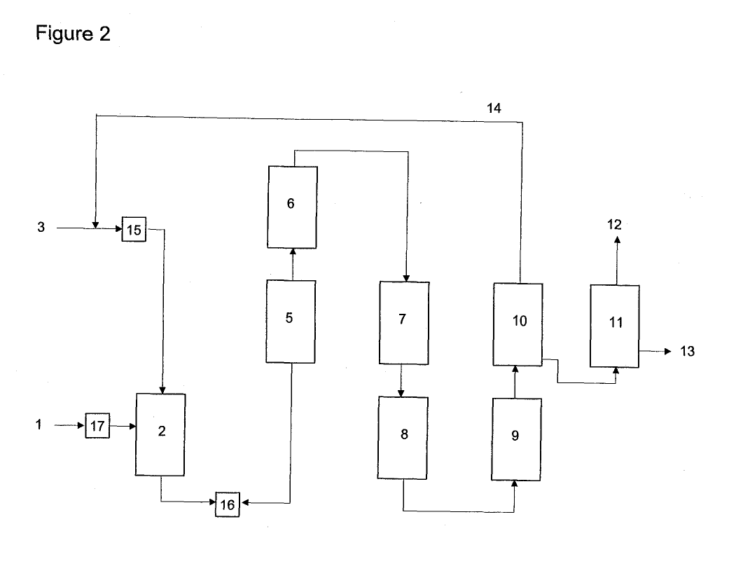

FIG. 2 shows a schematic process flow diagram for the reaction of a solid isocyanate residue. The process is similar to that for the workup of the liquid residue. However, the solid residue first has to be comminuted with a mill 17. The vessel 4 can be dispensed with here.

In the reaction of polyurethane residues by the process according to the invention, the polyols formed in the reaction, after the removal of the amine, are either used directly to prepare polyurethanes without removal of the unconverted reactants or purified, for example by distillation or extraction. Afterward, they can be reused to prepare polyurethanes.

The process has considerable advantages over the hydrolysis of isocyanate adducts. For instance, the process can be operated at lower pressures and temperatures, since the critical point of ammonia is lower than that of water and of mixtures of water and ammonia.

Since no water is used and formed in the process according to the invention, the costly and inconvenient removal of the water from the reaction product can be dispensed with. This is particularly significant, since even traces of water in the phosgenation of the amines can lead to operational disruption owing to solid formation and/or corrosion.

Furthermore, in the case of the reaction of isocyanate adducts based on TDI, a higher selectivity for TDA is achieved, since aminocresols cannot be formed by subsequent reactions with water.

Moreover, no carbon dioxide, which would lead to a pressure rise in the reactor, is formed in the ammonolysis.

The process will be described in detail using the examples which follow.

The apparatus consists of a 5 ml autoclave made of Inconel 625 which is equipped with a thermoelement, a burst disk (burst pressure 400 bar), a manometer and a high-pressure valve. The apparatus can be evacuated with an oil pump and charged under inert gas and emptied.

In the case of a typical batch, the reactor was charged with 0.07 g of reactant to be converted according to the table. Subsequently, ammonium was introduced. The reactor was heated in an oven. After 30 min, the reactor was taken from the oven, cooled and decompressed. The yields were determined by means of calibrated gas chromatography (GC) measurements. The starting materials used, the pressures, the temperatures in the reaction and the GC yields are shown in the table which follows.

### EXAMPLES

| | | | | List residue | |
|---|---|---|---|---|---|
| | Oligomeric | List residue | List residue | (TDI content <1% | |
| | carbodiimide | (TDI content <1% | (TDI content <1% | by wt.) | PU |
| Reactant | based on TDI | by wt.) | by wt.) | (C) | foam |
| Temp. [° C.] | 185 | 148 | 137 | 86 | 150 |
| Pressure [bar] | 200 | 380 | 180 | 320 | 176 |
| % by wt. of NH₃ | 60 | 90 | 90 | 90 | 75 |
| in the overall | | | | | |
| mixture | | | | | |
| TDA yield | >90% | >90 | 86 | 20 | 84 |

### C—Comparative Example with Noncritical Ammonia

The PU foam was a flexible polyurethane slab foam based on TDI and a trifunctional polyether alcohol based on glycerol, ethylene oxide and propylene oxide with a hydroxyl number of 36 mgKOH/g.

What is claimed is:

1. A process for working up isocyanate adducts, comprising the steps of
a) reacting the isocyanate adducts with pure ammonia,
b) working up the reaction products obtained in step a),
c) recycling the amines formed into the isocyanate production.

2. The process according to claim 1, wherein the reaction is conducted in such a way that ammonia is present in the supercritical state or close to the critical point.

3. The process according to claim 1, wherein the ammonia is present in an at least equimolar amount with respect to the bond to be cleaved.

4. The process according to claim 1, wherein the reaction is carried out at a temperature in the range between 100 and 500° C. and a pressure in the range between 100 and 500 bar.

5. The process according to claim 1, wherein the isocyanate adducts are reaction products of the isocyanates with themselves or with compounds having functional groups which can react with isocyanate groups.

6. The process according to claim 1, wherein the isocyanate adducts are selected from the group comprising compact or foamed polyurethanes, isocyanurates, uretonimines, uretdiones, carbodiimides, and also oligomeric and polymeric reaction products of the isocyanates.

7. The process according to claim 1, wherein the isocyanate adducts are liquid or solid distillation residues from the preparation of isocyanates.

8. The process according to claim 1, wherein the isocyanate adducts are liquid or solid distillation residues from TDI preparation.

9. The process according to claim 1, wherein the solid isocyanate adducts are comminuted before the reaction.

10. The process according to claim 1, wherein the solid isocyanate adducts are comminuted before the reaction to a particle size of <100 mm.

11. The process according to claim 1, wherein the reaction is carried out in tubular reactors, in tanks or in stirred tank batteries.

12. The process according to claim 1, wherein the free TDI is removed from the distillation residues of TDI preparation before the reaction with the ammonia.
